(19) United States
(12) Patent Application Publication
(10) Pub. No.: US 2023/0182166 A1
(43) Pub. Date: Jun. 15, 2023

(54) ROBOTIC COATING SYSTEM WITH REAL-TIME MIXING

(71) Applicant: Phillip G. Langhorst, Crestwood, MO (US)

(72) Inventor: Phillip G. Langhorst, Crestwood, MO (US)

(21) Appl. No.: 18/080,525

(22) Filed: Dec. 13, 2022

Related U.S. Application Data
(60) Provisional application No. 63/288,787, filed on Dec. 13, 2021.

(51) Int. Cl. B05C 11/10; B05C 1/02; B25J 11/00

(52) U.S. Cl. CPC B05C 11/1002; B05C 1/025; B25J 11/0075; B25J 9/026

(57) ABSTRACT

A Robotic Coating System with Real-Time Mixing has a particular arrangement of a robotic gantry, two peristaltic pumps, a mixer, a hollow brush, two tanks, and a computerized controller. The invention has tubes providing fluid communication from a coating tank and a thinner tank through the pumps and mixer to the brush. The invention provides everything necessary for robotic coating in one compact system. This invention provides the ability to apply coatings to an item, without pre-mixing the coating components. A computerized controller drives the brush through a pre-programmed path to coat required areas and not coat sensitive areas. The System operates upon utility service, typically 110 VAC, and it also self-cleans.

### CROSS-REFERENCE TO RELATED APPLICATION

This non provisional application claims priority to Provisional Application Ser. No. 63/288787 filed on Dec. 13, 2021 which has a common inventor.

### FIELD OF THE INVENTION

This invention relates to the coating of items for the purposes of sealing the items against moisture and dust, of applying color to improve an item’s appearance, or of adding dielectric material to improve electrical properties.

### BACKGROUND OF THE INVENTION

In workshops, classrooms, and small laboratories people often apply coatings manually with a brush or a spray gun. In those locations and also larger laboratories, factories, and assembly plants, production lines also apply coatings automatically using a robotic arm or a gantry. Many coatings have a composition of two liquid parts, such as a coating and a thinner, or a coating and a hardener, or an epoxy.

Many items, such as printed circuit boards, electrical components of many kinds, aircraft components, and others, must receive and retain a coating to protect them from moisture, corrosion, handling, and other hazards. In some cases, an entire item cannot receive a coating simultaneously because sensitive areas such as treads, connectors, sensors, and the like, would have damage inflicted upon them by the coating, its curing, and handling. To avoid that damage, existing technologies apply the coating preferentially in specific locations. The prior art accomplishes this with manual techniques with a brush or a hand air sprayer, or robotically by masking sensitive areas then spraying or dripping the coating upon the item.

Generally, the coating comes in a concentrated form, and it requires dilution before applying it upon an item. Dilution often occurs as a batch process, with the two components poured into a large can and then mixed into a solution before depositing the solution on an item. A weakness of this approach comes from the amount of mixed coating solution becoming difficult to predict, and from any mixed coating solution from one day may harden and fail to qualify for use the next day. If an insufficient volume of coating solution has been prepared, a depositing operation must stop while mixing occurs for another batch of coating solution.

### DESCRIPTION OF THE PRIOR ART

Robotic systems exist which can apply coatings via spray or drip. These systems use premixed material from a tank, sometimes with a motorized mixer running constantly to prevent the mixture settling. Sometimes mixing occurs as-needed basis in a separate room. The separate mixing room works well for large operations such as paint booths or dip tanks for painting cars upon assembly line. But that calls for too much space for small companies coating smaller items such as printed circuit boards.

The Robotic Coating System with Real-Time Mixing overcomes the above-mentioned disadvantages and drawbacks of the prior art. As such, the general purpose of the present invention, which will be described subsequently in greater detail, is to provide new and improved System which has all the advantages of the prior art mentioned heretofore and many novel features that result in a System which are not anticipated, rendered obvious, suggested, or even implied by the prior art, either alone or in any combination thereof.

### SUMMARY OF THE INVENTION

The present invention of the Robotic Coating System with Real-Time Mixing arranges as a computerized controller, a three-axis robotic gantry, tanks, metering pumps, a static mixer and a hollow brush. The robotic gantry can carry the mixer and brush to any point in three-dimensional space with X, Y, and Z axes. The computerized controller directs the robotic gantry to place the brush in a position upon the item and guides the brush to follow a pre-programmed path about the item. The computerized controller also turns the pumps on and off and controls their speed to deliver the necessary amount of coating and thinner to the brush and upon the item. The invention has separate pumps for coating and for thinner. By adjusting the ratio of the speeds of these two pumps, the invention varies the viscosity of the applied coating. Viscosity variation becomes important because when depositing coating around critical parts of an item , such as connectors or sensors, the coating can have high viscosity or appear thick, so that it does not bleed into areas which do not need coating. Alternatively, the invention supplies a mandatory second part to a first part of a formulation, such as an epoxy. Alternatively, the invention makes the coating thinner for use in broad, flat areas, where a better finish is desired. The two pumps deliver the coating and thinner via tubes to a static mixer. The static mixer has crossing internal paths which cause the two components to mix thoroughly by time they exit the mixer as a coating solution. The mixer connects via a very short tube to a hollow applicator brush. By tightly coupling the mixer to the applicator brush, little coating solution is in process. The invention can thus stop at any time upon command and little coating material will go to waste. Mixing as needed like this has the names of “real time mixing” or “on-the-fly mixing.”

There has thus been outlined, rather broadly, the more important features of the invention in order that the detailed description thereof that follows may be better understood and that the present contribution to the art may be better appreciated. Other attributes of the invention include simultaneous pump speed adjustment, independent pump speed adjustment, self-cleaning capability, avoidance of sensitive areas on an item to be coated, low volume of coating solution in short tube, operates upon 110 VAC utility service, and single unit construction. Additional features of the invention will be described hereinafter, and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a Robotic Coating System with Real-Time Mixing that apples a coating preferentially in specific locations.

Another object is to provide such a System that mixes two components into a coating solution in real time.

Another object is to provide such a System that has tanks and mixing equipment within the same frame and does not have separate locations for tanks and mixing equipment.

Another object is to provide such a System that avoids spillage and its resulting mess by avoiding manual or automated pouring of a coating solution or its component parts from original containers.

Another object is to provide such a System that has no manual mixing.

Another object is to provide such a System that eliminates an operator’s use of masking upon sensitive areas of items that receive a coating from this System.

Another object is to provide such a System that has its tanks, pumps, mixer, and robotic applicator in one unit.

Another object is to provide such a System that has one unit construction which provides a convenient, corn pact, and cost-effective coating system.

Another object is to provide such a System that operates upon 110 VAC current from a utility or other power source.

Another object is to provide such a System that may be easily and efficiently manufactured and marketed to the industry, purchasing officers, and others of the consuming public.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 shows an isometric view of the preferred embodiment of the present invention;

FIG. 2 shows an isometric view of an alternate embodiment of the present invention; and

FIG. 3 provides a top view of a plate of an alternate embodiment of the present invention.

The same reference numerals refer to the same parts throughout the various figures.

### DESCRIPTION OF THE PREFERRED EMBODIMENT

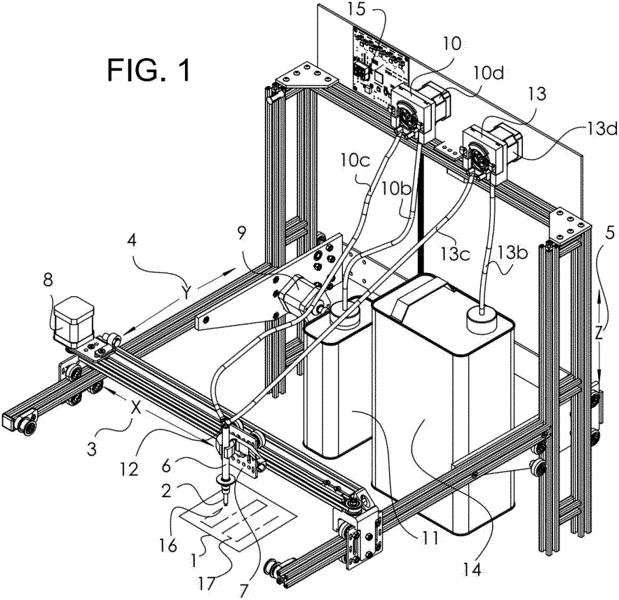

The present invention overcomes the prior art limitations by providing a Robotic Coating System with Real-Time Mixing for use in factories, assembly plants, bench manufacturing, laboratories, classrooms, and the like. FIG. 1 shows the Robotic Coating System with Real-Time Mixing of the invention in an isometric view.

FIG. 1 shows an isometric view of the preferred embodiment of the present invention. Beneath the invention, this figure shows a rectangular item 1 to receive a coating. The invention has its a gantry system capable of moving a brush 2 in the X direction as at 3, the Y direction as at 4, and the Z direction as at 5. The brush 2 has a coupled connection to a static mixer 6 that mounts to a coat head 7. A first motor 8 moves the coat head 7 in the X direction 3. A second motor 9 then moves the coat head in the Y direction 4. A third motor, not shown, then moves the coat head vertically, that is, up and down, in the Z direction 5. In an alternate embodiment, the invention has two third motors, each installed upon the five-sided plates upon each rail of the invention with one plate shown behind the second motor 9. Each third motor drives a wheel outwardly from each plate behind motor 9.

A first pump 10 is of a peristaltic type and draws a liquid, such as liquid coating material, from an installed tank 11 through a tube 10b and delivers the liquid coating material to a mixer 6 through a second tube 10c via a Y shaped fitting 12. Alternatively, the invention utilizes a T shaped fitting.

A second pump 13 is also of a peristaltic type and draws a liquid, such as liquid thinner material, from an installed second tank 14 through a third tube 13b and delivers the liquid thinner material to the mixer 6 through fourth tube 13c via the Y shaped fitting 12.

The Y shaped fitting 12 has upward branches that receive the second tube 10c and the fourth tube 13c and a stem -away from the branches- that connects to the mixer 6. In an alternate embodiment the invention has a short section of tube in fluid communication from the mixer to the stem of the fitting 12. The mixer has a slender cylinder form as shown. The liquid coating material and liquid thinner material undergo mixing through crossing passages within the mixer 6. The resulting coating solution, including coating and thinner, passes through the hollow brush 2 and then deposits upon the item 1. The coating solution cooperates and utilizes the capillary action of the bristles of the brush 2 to provide a smooth deposit of the coating upon the item evenly distributed in distance and in time. In the preferred embodiment, the bristles have a collective width of no more than 0.20 inches. One strand of bristle has a width, often a diameter of at least 0.00067 inches. Also, in one mode of operation, if the invention operates with its second pump 13 turned off, the first pump 10 provides solely liquid coating material into the mixer 6. This mode occurs when the liquid coating material does not call for dilution.

In operation, the computerized controller 15, is in control of all the motors. The computerized controller 15 positions the brush 2 to a starting position, as at 16, on the item 1 by driving the first motor 8, the second motor 9, and the third motor, moving the brush 2 along the respective X axis as at 3, Y axis as at 4, and Z axis as at 5. The computerized controller 15 starts the flow of coating by causing a pump motor 10d to run. The computerized controller 15 starts the flow of thinner by causing a pump motor 13d to run. The computerized controller 15 has the ability to run both pump motors, 10d, 13d, at different speeds, thereby effecting the ratio of liquid coating material to liquid thinner material and the subsequent viscosity of the mixed coating solution. By driving first motor 8, the second motor 9, and third motor, the computerized controller 15 moves the brush along a pre-programmed path, shown as zig zag line as at 17 along the three axes, as at 3, 4, 5. Also, the computerized controller 15 can stop the flow of coating and thinner at any moment and drive the motors 8, 9 and third motor such that the brush 2 goes around, or over, any part of the item which does not need to receive coating solution.

If the item to receive coating solution has a much smaller surface area than the usable area of the robotic gantry, the invention permits coating several items sequentially in the same batch. In this mode of operation, once the pre-programmed path of the first item 1 concludes, the computerized controller 15 stops the flow of coating material and thinner material, moves the brush 2 to the starting position of a second item 1′ , and restarts the coating process.

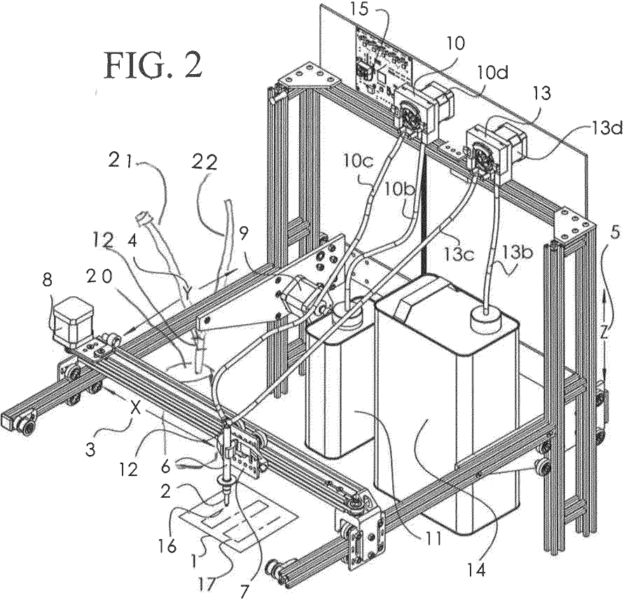

FIG. 2 then provides an isometric view of an alternate embodiment of the invention. In this alternate embodiment, the invention provides a third tank 20 located proximate the first tank 10 and within the gantry of the invention. The third tank receives waste fluid, such as coating solution, and thinner used to flush the invention, particularly tubes 10b, 10c, and from the mixer 6. The third tank has a fifth tube 21 and a sixth tube 22 that stay disconnected from the invention during normal usage. Following normal usage, an operator connects the fifth tube and the sixth tube to the first pump 10 and to the mixer 6 for receiving surplus coating solution ejected by further dispensing of thinner material from the second pump. The third tank and related tubes allow the invention to self-clean. The brush 2 of the invention also separates from the mixer and an operator then cleans the bristles.

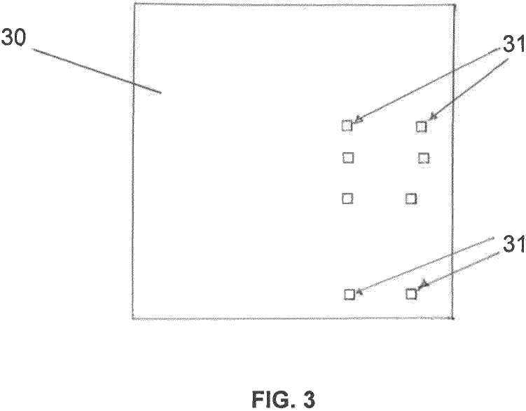

And, FIG. 3 illustrates a top view of a plate 30 generally positioned at the bottom of the invention when fully assembled with its housing, not shown. The plate fits below the invention and receives the first tank 11 and the second tank 14 installed upon it by an operator. More precisely, the plate has magnets 31 joined to it and spaced apart to receive the two tanks 11, 14 upon their installation by an operator. The magnets join to the plate by their own magnetism, welding, adhesive, or mechanical fastener such as a rivet or a bolt. The magnets provide attraction to the ferrous material of the installed can construction. In the preferred embodiment, the magnets arrange to fit inside the bottom rims of the two tanks. In an alternate embodiment, the magnets arrange to receive the bottom rims of the two ranks with the magnet’s arrangement.

The present invention operates as a system of components as described above. The system deposits a liquid coating solution along a path upon at least one item positioned within the gantry. The gantry operates electrically using 110 VAC. The liquid coating solution has at least a coating and may have a thinner. The system has its first component, a first electric pump of peristaltic operation with a stepper motor. The system continues with a second electric pump also of peristaltic operation with its stepper motor. A controller has electrical communication with the first pump, the second pump, and the gantry. The first pump has fluid communication with an installed first tank, that is, a tank placed within the invention by an operator. The second pump also has fluid communication with an installed second tank. The invention has a mixer upon the gantry where the mixer has a brush that deposits the coating solution upon at least one item while the gantry moves the brush upon three axes of motion. The invention then has its Y shaped fitting in fluid communication to the mixer opposite the brush.

The first pump has its fluid communication continue to the fitting and the second pump also has further fluid communication to the fitting, as in a second branch of the Y shape. The fitting admits the coating and the thinner into the mixer. Then the mixer blends the coating and the thinner into a coating solution delivered into the brush. The brush has bristles that move the solution utilizing gravity and capillary action. The bristles collectively make the brush have a width no more than 0.20 inches. The controller operating the first pump, the second pump, and the gantry independently of each other. The first pump operates in a range from zero to 100 per cent, and the second pump also operates in a range from zero to 100 per cent. These ranges allow the coating solution to be all coating, a blend of coating and thinner, and all thinner, as during self-cleaning. The controller also regulates the first pump and the second pump independently of each other which includes one or other pump being off as the other is on. The controller, the first pump, and the second pump cooperatively -as in together-produce a coating solution from 0 per cent of liquid from the second tank to 100 per cent of liquid from the first tank.

The invention also has a tube from the first tank to the first pump and a second tube from the first pump to the fitting. The invention then has a third tube from the second tank to the second pump and a fourth tube from the second pump to the fitting. The tube, the second tube, the third tube, and the fourth tube being slender, elongated, and flexible.

The invention also has a self-cleaning cycle. For that, the invention’s system has a third tank. Preferably the third tank has a permanent attachment to the gantry. The third tank receives waste fluid during the self-cleaning of the system. The third tank has a fifth tube in fluid communication from it for discharging waste fluid following conclusion of self-cleaning of said system. In an alternate embodiment, the third tank has a sixth tube that an operator connects to the first pump, or the second pump to eject fluid and clear other tubes in communication therewith. Overall, the system of the invention is self-cleaning. As a reminder, the brush has bristles with a diameter of at least a human hair, that is, at least 0.00067 inches, and collectively making the brush have its diameter, or its width, no more than 0.2 inches.

From the aforementioned description, a Robotic Coating System with Real-Time Mixing has been described. The System is uniquely capable of mixing a coating solution and depositing it within a compact frame. The System and its various components may be manufactured from many materials, including but not limited to, vinyl, polymers, such as nylon, polypropylene, polyvinyl chloride, high density polyethylene, polypropylene, ferrous and non-ferrous metals, their alloys, foils, and composites.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like -when they appear- are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A system that deposits a coating solution in a controlled manner upon at least one item, said coating solution comprising a coating and a thinner, said system comprising:
a gantry;
a first electric pump being peristaltic and having its pump motor;
a second electric pump being peristaltic and having its pump motor;
a controller being in electrical communication with said first pump, said second pump, and said gantry;
said first pump is adapted to be in fluid communication with an installed first tank;
said second pump is adapted to be in fluid communication with an installed second tank;
a mixer upon said gantry, said mixer having a brush is adapted to deposit coating solution upon at least one item, and said gantry moving said brush upon three axes;
a fitting in fluid communication to said mixer and said fitting positioned opposite said brush;
said first pump being in further fluid communication to said fitting and said second pump being in further fluid communication to said fitting;
wherein said fitting is adapted to admit coating and thinner into said mixer;
wherein said mixer is adapted to blend coating and thinner into a coating solution delivered into said brush; and
said controller operating said first pump, said second pump, and said gantry independently.

2. The system that deposits a coating solution of claim 1 further comprising:
said first pump operating in a range from zero to 100 per cent; and
said second pump operating in a range from zero to 100 per cent.

3. The system that deposits a coating solution of claim 2 further comprising:
said controller regulating said first pump and said second pump wherein said first pump and said second pump operate independently.

4. The system that deposits a coating solution of claim 3 further comprising:
said controller, said first pump, and said second pump is adapted to cooperatively produce a coating solution from 0 per cent from said second tank to 100 per cent from said first tank.

5. The system that deposits a coating solution of claim 1 further comprising:
the pump motor of said first pump being a stepper motor; and
the pump motor of said second pump being a stepper motor.

6. The system that deposits a coating solution of claim 1 further comprising:
said fitting in fluid communication to said mixer having a Y shape;
a tube from said first tank to said first pump and a second tube from said first pump to said fitting; and
a third tube from said second tank to said second pump and a fourth tube from said second pump to said fitting.

7. The system that deposits a coating solution of claim 6 further comprising:
said tube, said second tube, said third tube, and said fourth tube being slender, elongated, and flexible.

8. The system that deposits a coating solution of claim 1 further comprising:
said brush having bristles and said bristles collectively being no more than 0.2 inch in width.

9. The system that deposits a coating solution of claim 1 further comprising:
a third tank, said third tank is adapted to receive waste fluid during a self-cleaning of said system; and
a fifth tube in fluid communication from said third tank for discharging waste fluid after conclusion of self-cleaning of said system.

10. A system that deposits a liquid coating solution in a controlled manner upon at least one item, said system having an electrically operated gantry, said liquid coating solution comprising a coating and a thinner, said system comprising:
at least one electric pump being peristaltic and having its pump motor;
a controller being in electrical communication with said at least one electric pump and the gantry;
said at least one electric pump is adapted to be in fluid communication with an installed tank;
a mixer upon the gantry, said mixer having a brush is adapted to deposit coating solution upon at least one item, and wherein said brush moves upon three axes by the gantry;
a fitting in fluid communication to said mixer and said fitting positioned opposite said brush;
said at least one electric pump being in further fluid communication to said fitting;
wherein said fitting is adapted to admit at least one of a coating and a thinner into said mixer;
wherein said mixer is adapted to blend at least one of a coating and a thinner into a coating solution delivered into said brush; and
said controller operating said at least one electric pump and the gantry independently.

11. The system that deposits a liquid coating solution of claim 10 further comprising:
said at least one electric pump including a first pump being peristaltic and having its pump motor and a second pump being peristaltic and having its pump motor;
said first pump is adapted to be in fluid communication with an installed tank;
said second pump is adapted to be in fluid communication with an installed second tank;
said controller being in electrical communication with said first pump, said second pump, and the gantry;
said first pump being in further fluid communication to said fitting and said second pump being in further fluid communication to said fitting;
wherein said fitting is adapted to admit a coating and a thinner into said mixer;
wherein said mixer is adapted to blend a coating and a thinner into a coating solution delivered into said brush; and
said controller operating said first pump, said second pump, and said gantry independently.

12. The system that deposits a liquid coating solution of claim 11 further comprising:
said first pump operating in a range from zero per cent to 100 per cent;
said second pump operating in a range from zero per cent to 100 per cent;
said controller regulating said first pump and said second pump wherein said first pump and said second pump operate independently of each other.

13. The system that deposits a liquid coating solution of claim 12 further comprising:
said controller, said first pump, and said second pump is adapted to cooperatively produce a coating solution from 0 per cent from said second tank to 100 per cent from said first tank.

14. The system that deposits a liquid coating solution of claim 11 further comprising:
the pump motor of said first pump being a stepper motor; and
the pump motor of said second pump being a stepper motor.

15. The system that deposits a liquid coating solution of claim 11 further comprising:
said fitting in fluid communication to said mixer having a Y shape;
a tube from said first tank to said first pump and a second tube from said first pump to said fitting; and
a third tube from said second tank to said second pump and a fourth tube from said second pump to said fitting.

16. The system that deposits a liquid coating solution of claim 15 further comprising:
said tube, said second tube, said third tube, and said fourth tube being slender, elongated, and flexible;
said tube, said first pump, and said second tube providing fluid communication from said first tank to said fitting; and
said third tube, said second pump, and said fourth tube providing fluid communication from said second tank to said fitting.

17. The system that deposits a liquid coating solution of claim 11 further comprising:
said brush having bristles, said bristles receiving liquid coating solution from said mixer;
said bristles applying the liquid coating solution upon a path upon the item when the gantry lowers said brush upon the item;
said bristles retaining the liquid coating solution within said brush when the gantry raises said brush above the item; and
said brush having said bristles collectively no more than 0.2 inch in width.

18. The system that deposits a liquid coating solution of claim 11 further comprising:
a third tank, said third tank is adapted to receive waste fluid during a self-cleaning of said system; and
at least one tube in fluid communication from said third tank for discharging waste fluid following conclusion of self-cleaning of said system.

19. A system that deposits a liquid coating solution along a path upon at least one item, said system having an electrically operated gantry, said liquid coating solution comprising a coating and a thinner, said system comprising:
a first electric pump being peristaltic and having its pump motor as a stepper motor;
a second electric pump being peristaltic and having its pump motor as a stepper motor;
a controller being in electrical communication with said first pump, said second pump, and the gantry;
said first pump is adapted to be in fluid communication with an installed first tank;
said second pump is adapted to be in fluid communication with an installed second tank;
a mixer upon the gantry, said mixer having a brush is adapted to deposit coating solution upon at least one item, and the gantry moving said brush upon three axes;
a Y shaped fitting in fluid communication to said mixer and said fitting positioned opposite said brush;
said first pump being in further fluid communication to said fitting and said second pump being in further fluid communication to said fitting;
wherein said fitting is adapted to admit coating and thinner into said mixer;
wherein said mixer is adapted to blend coating and thinner into a coating solution delivered into said brush;
said controller operating said first pump, said second pump, and said gantry independently.
said first pump operating in a range from zero per cent to 100 per cent, and
said second pump operating in a range from zero per cent to 100 per cent;
said controller regulating said first pump and said second pump independently of each other;
said controller, said first pump, and said second pump is adapted to cooperatively produce a coating solution from 0 per cent from said second tank to 100 per cent from said first tank;
a tube from said first tank to said first pump and a second tube from said first pump to said fitting, and a third tube from said second tank to said second pump and a fourth tube from said second pump to said fitting; and
said tube, said second tube, said third tube, and said fourth tube being slender, elongated, and flexible.

20. The system that deposits a liquid coating solution of claim 19 further comprising:
a third tank, said third tank is adapted to receive waste fluid during a self-cleaning of said system;
a fifth tube in fluid communication from said third tank for discharging waste fluid following conclusion of self-cleaning of said system;
wherein said system is adapted to be self-cleaning; and
said brush having bristles and said brush being no more than 0.2 inch in width.
